(19) United States
(12) Patent Application Publication
(10) Pub. No.: US 2019/0145225 A1
(43) Pub. Date: May 16, 2019

(54) TIME-DEPENDENT SPATIAL DISTRIBUTION OF AT LEAST ONE FLOW PARAMETER IN A NETWORK OF FRACTURES

(71) Applicant: Halliburton Energy Services, Inc., Houston, TX (US)

(72) Inventors: Zhexuan Zhang, Frisco, TX (US); Srinath Madasu, Houston, TX (US); Avi Lin, Houston, TX (US)

(21) Appl. No.: 16/097,545

(22) PCT Filed: Aug. 4, 2016
(86) PCT No.: PCT/US2016/044884

§ 371 Date: Oct. 29, 2018

(51) Int. Cl. E21B 41/00; E21B 43/26; G05B 13/04; G01V 99/00

(52) U.S. Cl. CPC E21B 41/0092; E21B 43/26; E21B 47/06; G01V 99/005; G05B 13/042

(57) ABSTRACT

A hydraulic fracturing flow simulation method includes identifying a network of fractures including junctions where the fractures intersect. Each fracture accesses each associated junction via a respective opening. The method further includes determining a current network state that includes flow parameter values at discrete points arranged one-dimensionally along the fractures in the network and at discrete points arranged two-dimensionally across the junctions in the network. The method further includes constructing a set of equations for deriving a subsequent network state from the current network state while accounting for boundary layers at each opening. The method further includes repeatedly solving the set of equations to obtain a sequence of subsequent network states. The sequence embodies a time-dependent spatial distribution of at least one flow parameter. The method further includes displaying the time-dependent spatial distribution.

### BACKGROUND

In the oil and gas industry, unconventional reservoirs often have a low-permeability rock matrix that impedes fluid flow, making it difficult to extract hydrocarbons (or other fluids of interest) at commercially-feasible rates and volumes. Fortunately, the effective permeability of the formation can be increased by hydraulic fracturing. When the rock matrix is exposed to a high-pressure high-volume flow of a relatively incompressible fluid, the low permeability causes sharp gradients in the formation's stress field, forcing integrity failures at the relatively weakest points of the rock matrix. Such failures often occur as a sudden “cracking” or fracturing of the matrix that momentarily reduces the stress gradient until it can be rebuilt by the intruding fluid flow. As the high-pressure flow continues, the fractures may propagate, for example, as an intermittent series of small cracks or branches. The injected fluid also deforms and shifts blocks of matrix material, complicating the fracture propagation analysis. Adding yet another complication, small grains of sand or other proppants may be added to the flow with the goal of keeping the fractures open after the fluid pressure is removed.

Accordingly, accurate simulation of the hydraulic fracturing operation requires that fluid flow phenomena be taken into account. However, the computational resources available for simulation are typically limited, making it a challenge to maximize the efficiency of the simulation process within these constraints while ensuring that the accuracy is sufficient to guide field operations.

### NOTATION AND NOMENCLATURE

Certain terms are used throughout the following description and claims to refer to particular system components and configurations. As one of ordinary skill will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or a direct electrical or physical connection. Thus, if a first device couples to a second device, that connection may be through a direct electrical connection, through an indirect electrical connection via other devices and connections, through a direct physical connection, or through an indirect physical connection via other devices and connections in various embodiments.

### BRIEF DESCRIPTION OF THE DRAWINGS

Accordingly, to optimize these tradeoffs, systems and methods using a time-dependent spatial distribution of at least one flow parameter in a network of fractures are disclosed herein. In the following detailed description of the various disclosed embodiments, reference will be made to the accompanying drawings in which:

FIG. 1 is a contextual view of an illustrative fracturing environment;

FIG. 2 is a block diagram of an illustrative system for fracturing simulation;

FIG. 3 is a diagram of an illustrative two-dimensional junction at which one-dimensional fractures intersect;

FIG. 4 is a diagram of an illustrative one-dimensional fracture representation;

FIG. 5 is a diagram of an illustrative computational mesh used for two-dimensional junction representation;

FIG. 6 is a flow diagram of an illustrative fracturing simulation method; and

FIG. 7 is two graphs embodying an illustrative predicted time-dependent spatial distribution.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

The issues identified in the background are at least partly addressed by systems and methods using a time-dependent spatial distribution of at least one flow parameter. Specifically, describing how fluids flow inside several one-dimensional fractures, or branches, shared by two-dimensional junctions at which the branches intersect allow for generation of the time-dependent spatial distribution. Analysis of the distribution, including predictions about the distribution, leads to real-time modification of the fracturing job to optimize production.

The disclosed systems and methods are best understood in terms of the context in which they are employed. As such, FIG. 1 shows the environment of an illustrative hydraulic fracturing operation. A wellbore 102 extends from the surface 104 into a subterranean region 106. Typically, the subterranean region 106 includes a reservoir that contains hydrocarbons or other resources such as, e.g., shale, coal, sandstone, granite, or other rocks with pores containing oil or natural gas. The subterranean region 106 may include naturally fractured rock or natural rock formations that are not fractured to any significant degree. When the subterranean region 106 includes tight gas formations (i.e., natural gas trapped in low permeability rock such as shale), it is typically desirable to create additional fractures in the formation to increase the formation's effective permeability.

Accordingly, FIG. 1 also shows an injection assembly coupled to supply a high-pressure, high-volume fluid flow via a conduit 108 to the wellbore 102. The injection assembly includes one or more pump trucks 110 and instrument trucks 112 that operate to inject fluid via the conduit 108 and the wellbore 102 into the subterranean region 106, thereby opening existing fractures and creating new fractures. The fluid reaches the formation via one or more fluid injection locations 114, which in many cases are perforations in the casing of wellbore 102. Such casing may be cemented to the wall of the wellbore 102, though this is not required. In some implementations, all or a portion of the wellbore 102 may be left open, i.e., without casing. The conduit 108 may include an injection manifold and feed pipe, as well as piping internal to the wellbore such as a work string, coiled tubing, sectioned pipe, or other type of conduit.

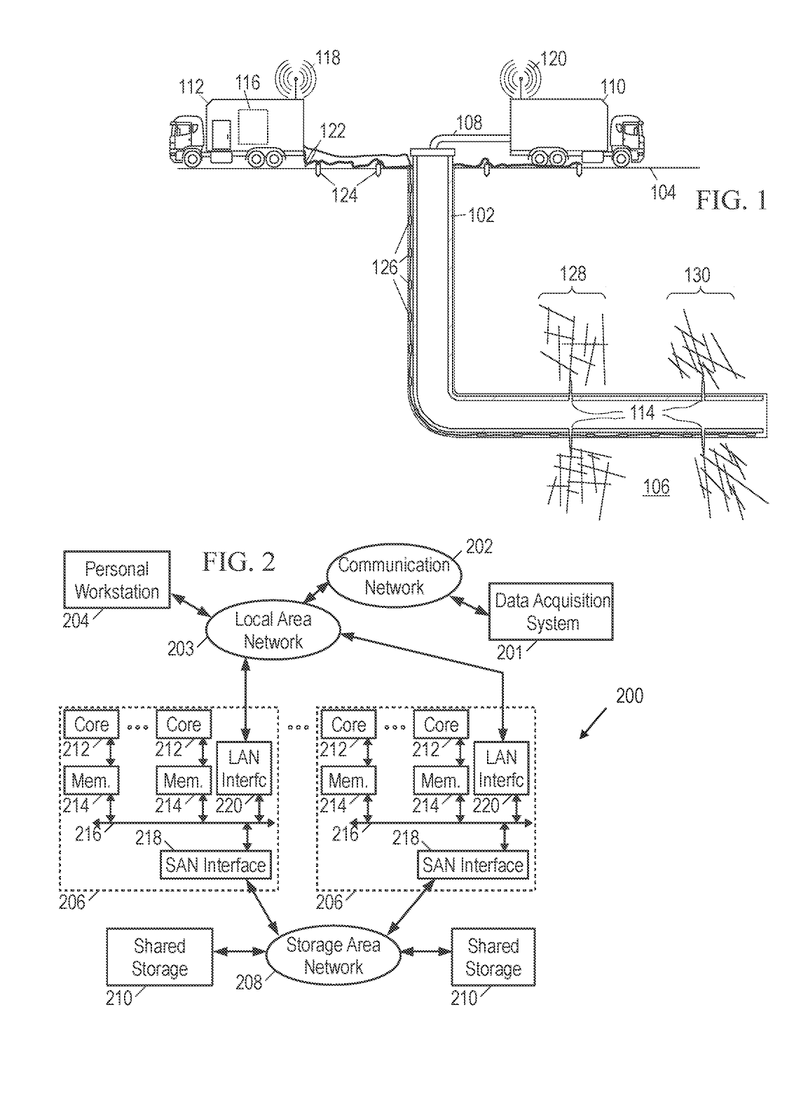

The fracture treatment may employ a single injection of fluid to one or more fluid injection locations 114, or it may employ multiple such injections, optionally with different fluids. Where multiple fluid injection locations 114 are employed, they can be stimulated concurrently or in stages. Moreover, they need not be located within the same wellbore 102, but may for example be distributed across multiple wells or multiple laterals within a well. A treatment control system 116 coordinates operation of the injection assembly components (pump trucks, feed tanks, throttles, valves, flow sensors, pressure sensors, etc.) to monitor and control the fracture treatment. Though shown as being localized to a single instrument truck 112, the treatment control system 116 may in practice take the form of multiple data acquisition and processing systems optionally distributed throughout the injection assembly and wellbore 102, as well as remotely-coupled offsite computing facilities available via communication links and networks. Though the computing system is described below in FIG. 2 as a separate entity for implementing hydraulic fracture simulation, some contemplated embodiments of the treatment control system 116 have the simulator as an integrated component.

The treatment control system 116 may periodically or continuously obtain measurement data as a function of position and/or time. Among other things, the treatment control system 116 processes data and generates a representative display for a user to perceive. Software may run on the treatment control system 116 to collect the data and organize it in a file or database stored on non-transient information storage media. Specifically, a processor coupled to memory may execute the software. The software may respond to user input via a keyboard or other input mechanism to display data as an image or movie on a monitor or other output mechanism. The software may process the data to optimize fracturing operations as described below. In at least one embodiment, the treatment control system 116, or a portion of the treatment control system 116, is located downhole within a housing able to protect the treatment control system 116 from the harsh downhole environment. In another embodiment, processors both at the surface and downhole may work together or independently to obtain, store, and process data. The treatment control system 116 may include computing hardware such as handheld mobile devices, tablets, notebooks, laptops, desktop computers, workstations, mainframes, distributed computing networks, and virtual (cloud) computing systems.

The treatment control system 116 may include data processing equipment, communication equipment, and other equipment for monitoring and controlling injection treatments applied to the subterranean region 106 through the wellbore 102. Additionally, the treatment control system 116 may be communicably linked to a remote computing facility that can calculate, select, or optimize treatment parameters for initiating, opening, extending, and conveying proppant into fractures. The treatment control system 116 may also receive, generate, or modify a fracture treatment plan (e.g., a pumping schedule) that specifies properties of a fracture treatment to be applied to the subterranean region 106. Based on simulated behavior, the treatment control system 116 shown in FIG. 1 controls operation of the injection assembly to optimize fluid compositions, flow rates, total flow volumes, injection pressure, and shut-in intervals.

The pump trucks 110 can include mobile vehicles, immobile installations, skids, hoses, tubes, fluid tanks, fluid reservoirs, pumps, valves, mixers, or other types of structures and equipment. They supply treatment fluid and other materials (e.g., proppants, cross linked gels, linear gels, surfactants, breakers, stop-loss materials) for the fracture treatment. The illustrated pump trucks 110 communicate treatment fluids into the wellbore 102 at or near the level of the ground surface 104. The pump trucks 110 are coupled to valves and pump controls for starting, monitoring, stopping, increasing, decreasing or otherwise controlling pumping as well as controls for selecting or otherwise controlling fluids pumped during the treatment.

The instrument trucks 112 can include mobile vehicles, immobile installations, or other suitable structures and sensors for measuring temperatures, pressures, flow rates, and other treatment, production, and flow parameters. The example instrument trucks 112 shown in FIG. 1 include a treatment control system 116 that controls or monitors the fracture treatment applied by the injection assembly. The injection assembly may inject fluid into the formation above, at, or below a fracture initiation pressure; above, at, or below a fracture closure pressure; or at another fluid pressure.

Communication links 118, 120 enable the instrument trucks 112 to communicate with the pump trucks 110 and other equipment at the ground surface 104. Additional communication links 122 enable the instrument trucks 112 to communicate with sensors or data collection apparatus in the wellbore 102, other wellbores, remote facilities, and other devices and equipment. The communication links can include wired or wireless communications assemblies, or a combination thereof. FIG. 1 shows communication links 122 for an array of surface seismic sensors 124 and an array of downhole seismic sensors 126 for detecting and locating microseismic events. Though downhole sensors 126 are shown as being positioned in the injection well, they can also or alternatively be located in one or more nearby monitoring wells. Sensors 124 and/or 126 detect seismic energy from the microseismic events that occur as fractures are formed and propagated. The received energy signals from the sensors are processed by the treatment control system 116 to determine the microseismic event locations, times, and magnitudes. Such information is indicative of the fracture locations and dimensions, which information may be used to determine when the fracturing operations should be terminated and how to carry out subsequent operations to achieve the desired results.

Specifically, FIG. 1 shows that a treatment has fractured the subterranean region 106, producing first and second fracture families 128, 130 from respective perforations 114. The induced fractures may extend through naturally fractured rock, regions of un-fractured rock, or both. The injected fracturing fluid can flow from the induced fractures into the natural fracture networks, into the rock matrix, or into other locations in the subterranean region 106 (e.g., faults, voids). The injected fracturing fluid can, in some instances, dilate or propagate the natural fractures or other pre-existing fractures in the rock formation. The formation and propagation of fractures produces microseismic events, which may be identified and located based on analysis of the signals from sensors 124 and 126. The progression of the fracturing operation can thus be monitored and such monitoring used to derive information useful for simulating the fracture networks that have been formed and which may be formed in future fracturing operations in the region.

In some implementations, the treatment control system 116 collects and analyzes the signals from sensors 124, 126 to map fractures, monitor the spatial distribution of injected fluids, and to control the fluid injection parameters to optimize the modification of effective formation permeability. For example, the treatment control system 116 can modify, update, or generate a fracture treatment plan (pumping rates, pressures, volumes, fluid compositions, and timing) based on the estimated spatial distributions of various fluid components determined by simulation as described with respect to FIG. 2.

FIG. 2 shows an illustrative computing system 200 in which a data acquisition system 201 represents the instrument trucks 112 and other sources of data regarding the well and surrounding formations. A communications network 202 (such as, e.g., the internet or other communications link for transferring digital data) couples the data acquisition system 201 to a local area network (“LAN”) 203 to communicate the data to a personal workstation 204. The data can include treatment program data, geological data, fracture data, fluid data, and the like. Workstation 204 may take the form of a desktop computer having a user interface (e.g., keyboard, pointer, and display) that enables the user to interact with the other elements of the computing system, e.g., by entering commands and viewing responses. In this fashion, the user or operator is able to retrieve the well data and make it available for simulation of flow in a network of fractures, flow predictions, and visualizations of flow within the fractures. For example, a visualization may be in an interactive form that enables the operator to enhance portions of the model and derive analytical results therefrom. The visual representation may depict spatial distributions of values and/or integrated values such as injected volumes, flow rates, fracture dimensions, and estimated permeabilities. In some contemplated embodiments, an analysis module further produces recommendations for real-time modifications to treatment plans that are underway. Alternatively, such analysis and modifications are implemented automatically, i.e., without human input.

Storage area network (“SAN”) 208 provides low-latency access to shared storage devices 210. The SAN 208 may take the form of, e.g., a Fibrechannel or Infiniband network. Shared storage units 210 may be large, stand-alone information storage units that employ magnetic disk media for nonvolatile data storage. Other suitable forms of nontransitory information storage media can also be employed. To improve data access speed and reliability, the shared storage units 210 may be configured as a redundant disk array (“RAID”).

The SAN 208 may store a measurement database including treatment program information such as a pumping schedule, flow rates, flow volumes, slurry concentrations, fluid compositions, injection locations, shut-in times, and the like. The measurement database may further include geological data relating to geological properties of a subterranean region. For example, the geological data may include information on wellbores, completions, or information on other attributes of the subterranean region. In some cases, the geological data includes information on the lithology, fluid content, stress profile (e.g., stress anisotropy, maximum and minimum horizontal stresses), pressure profile, spatial extent, natural fracture geometries, or other attributes of one or more rock formations in the subterranean zone. The geological data can include information collected from well logs, rock samples, outcroppings, microseismic imaging, tilt measurements, or other data sources.

The measurement database may still further include fluid data relating to well fluids and entrained materials. The fluid data may identify types of fluids, fluid properties, thermodynamic conditions, and other information related to well assembly fluids. The fluid data can include flow models for compressible or incompressible fluid flow. For example, the fluid data can include coefficients for systems of governing equations (e.g., Navier-Stokes equations, advection-diffusion equations, continuity equations, etc.) that represent fluid flow generally or fluid flow under certain types of conditions. In some cases, the governing flow equations define a nonlinear system of equations. The fluid data can include data related to native fluids that naturally reside in a subterranean region, treatment fluids to be injected into the subterranean region, hydraulic fluids that operate well assembly tools, or other fluids that may or may not be related to a well assembly.

Workstation 204 may lack sufficient internal resources to perform such processing in a timely fashion for complex fracture networks. As such, the LAN 203 may further couple the workstation 204 to one or more multi-processor computers 206, which are in turn coupled via a SAN 208 to one or more shared storage units 210. LAN 203 provides high-speed communication between multi-processor computers 206 and with personal workstation 204. The LAN 204 may take the form of an Ethernet network.

Multi-processor computer(s) 206 provide parallel processing capability to enable suitably prompt processing of the measurements and fracture simulation information to simulate fracture fluid flows. Each computer 206 includes multiple processors 212, distributed memory 214, an internal bus 216, a SAN interface 218, and a LAN interface 220. Each processor 212 operates on allocated tasks to solve a portion of the overall problem and contribute to at least a portion of the overall results. Associated with each processor 212 is a distributed memory module 214 that stores application software and a working data set for the processor's use. Internal bus 216 provides inter-processor communication and communication to the SAN or LAN networks via the corresponding interfaces 218, 220. Communication between processors in different computers 206 can be provided by LAN 204 or via a mailbox mechanism on storage devices 210.

The processors 212 may locate and simulate the flow of fluids along hydraulically induced fractures by fracture mapping, spatial discretization (separating the formation into zones), equation construction, and equation solving using information from the measurement database. Such simulations may include time-dependent spatial distribution of fluid flow parameters. Before detailing generation of time-dependent spatial distribution of flow parameters, a discussion of fractures and junctions will be helpful.

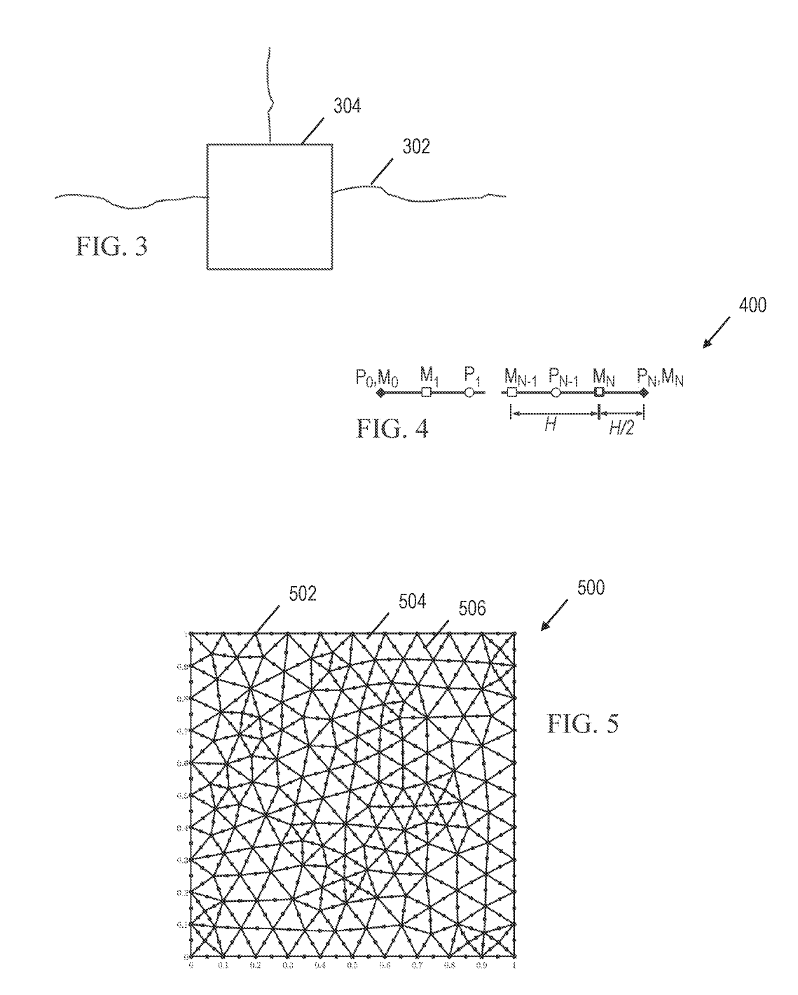

FIG. 3 illustrates three fractures 302 intersecting at a junction 304. Each fracture 302 accesses the junction 304 through a respective opening, thus allowing fluid to flow from the fracture 302 to the junction 304 or from the junction 304 to the fracture 302. The cross-section of the fractures 302 in the vicinity of the junction 304 is small compared to the length of the fractures 302. Therefore, it may be assumed that when entering the junction 304, the fluid flow in each of the fractures 302 exhibits one-dimensional flow characteristics. As such, for simulation purposes, the fractures 302 may be represented as one-dimensional elements as shown in FIG. 4.

FIG. 4 illustrates a one-dimensional fracture representation 400 (“fracture”). Although fractures are three-dimensional objects having a length, height, and aperture, the flow parameters are simulated as uniform across the height and aperture of the fracture enabling each fracture to be treated as a one dimensional element. The fracture 400 is divided into discrete points at which the flow parameters (flow rate, pressure, proppant concentration, diverter concentration, density, viscosity, and the like) are calculated. The differential equations that govern the simulated fluid flow exhibit improved numerical stability when the points at which the flow rate is calculated are offset or staggered from the remaining parameters. Accordingly, the points labeled Mᵢ are the ith points at which the mass flow rate is determined, and the points labeled Pᵢ are the ith points at which the pressure and the other fluid parameters are determined. Here, the endpoints are junction locations. Each pair of points Mᵢ, Pᵢ, represent a volume having a length of H. The distance from the junction to the adjacent discrete point is H/2.

The fracture 400 may be simulated using a finite-difference method. Specifically, the finite-difference method consists of approximating a differential operator by replacing derivatives in differential equations using differential quotients. The domain is partitioned in space and in time, and approximations of the solution are computed at certain space or time points. The error between the numerical solution and the exact solution is determined by the error that is committed by going from a differential operator to a difference operator. This error is called the discretization error.

The continuity and momentum equations at a discrete point 1 in the fracture 400 are:

$$\begin{matrix}\frac{d ( {A}_{1} {ρ}_{f} )}{dt} + \frac{d ( {A}_{1} {ρ}_{f} {U}_{1} )}{dx} = 0 & ( 1 ) \\ \frac{\partial {ρ}_{f} Au}{\partial t} + \frac{\partial {ρ}_{f} {Au}^{2}}{\partial x} + A \frac{\partial p}{\partial x} + A \frac{{f}_{f}}{π} {u}^{2} - μ \frac{{\partial }^{2} Au}{\partial {x}^{2}} = 0 & ( 2 )\end{matrix}$$

where t represents time, x represents position along the x-axis, and u represents fluid velocity along the x-axis. The continuity equation (1) is numerically approximated at a staggered point, Mᵢ, and the momentum equation (2) is numerically approximated at a non-staggered point, Pᵢ. While the fractures are simulated as one-dimensional elements, the junctions may be simulated as two-dimensional elements as shown in FIG. 5.

FIG. 5 illustrates a computation mesh 502 used to simulate junction 500 as a two-dimensional element using finite-element modeling. Specifically, the two-dimensional area is subdivided into non-overlapping components of simple geometry called finite elements 504. Here the finite elements 504 are triangles, but in various embodiments other geometries may be used. For each point 506 in the computation mesh 502, the flow's velocity in the junction 500 is u and v, and p is its pressure. Also, ρ and μ are fluid density and viscosity coefficients, which may be measured or obtained from a measurement database. The fluid flow within the junction is governed by:

$$\begin{matrix}{\int }_{Ω} ( {φρ}_{f} \frac{\partial Au}{\partial t} - φμ {∇}^{2} Au + A φ \frac{\partial p}{\partial x} ) d Ω = {\int }_{Ω} ( {φρ}_{f} \frac{\partial Au}{\partial t} + μ ∇ φ \cdot ∇ Au - Ap \frac{\partial φ}{\partial x} ) d Ω - μ {\int }_{Γ} φ ∇ Au \cdot nd Γ + {\int }_{Γ} Ap φ nd Γ & ( 3 ) \\ {\int }_{Ω} ( {φρ}_{f} \frac{\partial Av}{\partial t} - φμ {∇}^{2} Av + A φ \frac{\partial p}{\partial y} ) d Ω = {\int }_{Ω} ( {φρ}_{f} \frac{\partial Av}{\partial t} + μ ∇ φ \cdot ∇ Av - Ap \frac{\partial φ}{\partial y} ) d Ω - μ {\int }_{Γ} φ ∇ Av \cdot nd Γ + {\int }_{Γ} Ap φ nd Γ & ( 4 )\end{matrix}$$

where

$$u = {\sum }_{i = 1}^{N} {u}_{i} {φ}_{i} , v = {\sum }_{i = 1}^{N} {v}_{i} {φ}_{i} , p = {\sum }_{i = 1}^{M} {p}_{i} {ψ}_{i} ,$$

ϕ is the velocity shape function, ψ is the pressure shape function, N is the number of velocity measurements, and M is the number of pressure measurements.
The continuity equation at the junction 500 is:

$$\frac{{d ( {ρ}_{f} hA )}_{junction}}{dt} + \frac{\partial {ρ}_{f} uA}{\partial x} + \frac{\partial {ρ}_{f} vA}{\partial y} = 0 \qquad ( 5 )$$

where h, w and A represent the height, width and area of the junction 500 respectively.

Two connection conditions between the fractures and the junction are helpful to accurately simulate fluid flow. First, the velocity of fluid at the inlets to the junctions may be determined using the momentum equation (2). Second, the pressure at the junction's outlets may be determined using equation (18) discussed below. These conditions bridge, or connect, the finite-element framework of the junction simulation with the finite-difference framework of the fracture simulation. The connection conditions are based on preserving the fluid's momentum components, when traveling between the fractures and junction, without frictional loss, as well as the mass flux.

The pressure at the junction's outlets may be determined by using the Navier Stokes Equation:

$$\frac{\partial u}{\partial t} + u \frac{\partial u}{\partial x} + v \frac{\partial u}{\partial y} = - \frac{1}{ρ} ( \frac{dP}{dx} ) + v \frac{{\partial }^{2} u}{\partial {y}^{2}} \qquad ( 6 )$$

where t represents time, x represents position along the x-axis, y represents position along the y-axis, u represents fluid velocity along the x-axis, and v represent fluid velocity along the y-axis. Assuming P is constant, then:

$$\frac{\partial u}{\partial t} + u \frac{\partial u}{\partial x} + v \frac{\partial u}{\partial y} = - \frac{1}{ρ} ( \frac{dP}{dx} ) + v \frac{{\partial }^{2} u}{\partial {y}^{2}} \qquad ( 7 )$$

Integrating equation (7) from δ to W−2 δ, where w represents fracture width, and δ represents boundary layer thickness.

$${\int }_{δ}^{W - 2 δ} \frac{\partial u}{\partial t} dy + {\int }_{δ}^{W - 2 δ} u \frac{\partial u}{\partial x} dy = - \frac{1}{ρ} {\int }_{δ}^{W - 2 δ} \frac{dP}{dx} dy + {\int }_{δ}^{W - 2 δ} v \frac{{\partial }^{2} u}{\partial {y}^{2}} dy \qquad ( 8 )$$

For the first term in equation (8), applying the Leibnitz rule gives:

$$\begin{matrix}{\int }_{δ}^{W - 2 δ} \frac{\partial u}{\partial t} dy = \frac{\partial }{\partial t} {\int }_{δ}^{W - 2 δ} udy = \frac{\partial U}{\partial t} & ( 9 ) \\ {\int }_{δ}^{W - 2 δ} \frac{\partial {u}^{2}}{\partial x} dy = \frac{\partial }{\partial x} {\int }_{δ}^{W - 2 δ} {u}^{2} dy + {U}^{2} \frac{\partial δ}{\partial x} = \frac{\partial {U}^{2}}{\partial x} + {U}^{2} \frac{\partial δ}{\partial x} - {U}^{2} \frac{\partial ( W - 2 δ )}{\partial x} & ( 10 ) \\ \frac{1}{ρ} {\int }_{δ}^{W - 2 δ} \frac{\partial P}{\partial x} dy = \frac{1}{ρ} \frac{\partial }{\partial x} {\int }_{δ}^{W - 2 δ} Pdy & ( 11 ) \\ {\int }_{δ}^{W - 2 δ} v \frac{{\partial }^{2} u}{\partial {y}^{2}} dy = v \frac{\partial u}{\partial y} {\vert}_{y = δ}^{y = W - 2 δ} = 0 & ( 12 )\end{matrix}$$

Adding the equations (9-12) results in:

$$\frac{\partial U}{\partial t} + \frac{\partial {U}^{2}}{\partial x} + 3 {U}^{2} \frac{\partial δ}{\partial x} - {U}^{2} \frac{\partial W}{\partial x} + \frac{1}{ρ} \frac{\partial }{\partial x} P = 0 \qquad ( 13 )$$

where the analytical equations are adapted to the discrete domain for numerical simulation, i.e., moving from a differential operator to a difference operator. Denoting by delta x, the size of the computational grid, the pressure derivative may be approximated as:

$$\begin{matrix}\frac{\partial }{\partial x} \overline{P} = \frac{{\overline{P}}_{i} - {\overline{P}}_{junction}}{Δ x} & ( 14 ) \\ {\overline{P}}_{i} = {\overline{P}}_{junction} - ρΔ x ( \frac{\partial U}{\partial t} + \frac{\partial {U}^{2}}{\partial x} + 3 {U}^{2} \frac{\partial δ}{\partial x} - {U}^{2} \frac{\partial W}{\partial x} ) & ( 15 )\end{matrix}$$

where P_{junction} is obtained using the continuity equation (5). The zero order solution is:

$$\begin{matrix}{\overline{P}}_{i} = {\overline{P}}_{junction} & ( 16 ) \\ {( \frac{δ}{x} )}^{2} = \frac{30}{{Re}_{x}} & ( 17 ) \\ δ ( \frac{d δ}{dx} ) = \sqrt{\frac{15 υ}{{2}^{*} xU}} & ( 18 )\end{matrix}$$

Solving equations (13), (15), and (18) determines U and P of the fracture at the point nearest the junction, where W is the width of the fracture and δ is the thickness of the boundary layer. As such, the junction flow equations are connected to the fracture flow equations, and a relationship between the junction flow and fracture flow is determined.

Returning to FIG. 2, the equations described above may be constructed and solved by the processors 212. For example the processors 212 may form a processing module that determines a current network state that includes flow parameter values at discrete points arranged one-dimensionally along the fractures in the network, as shown in FIG. 4 using a finite-difference framework, and at discrete points arranged two-dimensionally across the junctions in the network, as shown in FIG. 5 using a finite-element framework. Next, the processing module constructs a set of equations for deriving a subsequent network state from the current network state while accounting for boundary layers at each opening.

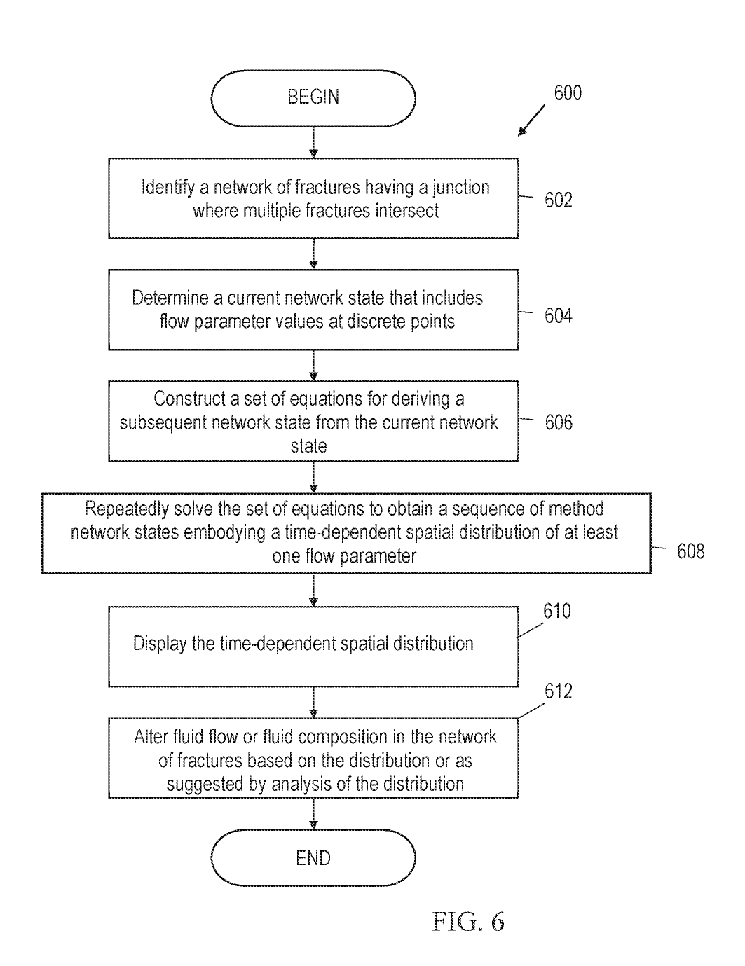

Subsequently, the processing module repeatedly solves the set of equations described above, constrained by conserving the mass flux of fluid that enters and exits the junction and conserving the momentum of fluid that enters and exits the junction through the openings, to obtain a sequence of subsequent network states. Specifically, the processing module determines velocities of fluid entering the junction and the pressures of the fluid exiting the junction using equations (2) and (18). In at least one embodiment, the pressures of the fluid are obtained from a boundary layer model. By solving the equations, the processing module may generate and display a time-dependent spatial distribution of at least one flow parameter in the network of fractures such as fluid velocity, pressure, proppant concentration, diverter concentration, temperature and the like. The processing module, or a separate fluid control module, may initiate alteration to fluid flow or fluid composition in the network of fractures based on the time-dependent spatial distribution as described with respect to FIG. 6.

FIG. 6 is a flow diagram of an illustrative method 600 of flow simulation. At 602, a processor, or multiple processors, such as the type described above identifies a network of fractures including junctions where the fractures intersect. Identifying the network may include obtaining information regarding the properties of the region and fluids to be simulated, including formation layering, permeability, injection rates, viscosities, and boundary conditions.

At 604, the processor determines a current network state that includes flow parameter values at discrete points arranged one-dimensionally along the fractures in the network, as shown in FIG. 4 using a finite-difference framework, and at discrete points arranged two-dimensionally across the junctions in the network, as shown in FIG. 5 using a finite-element framework.

At 606, the processor constructs a set of equations for deriving a subsequent network state from the current network state while accounting for boundary layers at each opening. For example, the equations described above may be constructed to determine connection conditions between the one-dimensional fractures and the two-dimensional junctions based on conserving of the fluid's mass flux through the junction and conserving the fluid's momentum at the junction.

At 608, the processor repeatedly solves the set of equations to obtain a sequence of network states. Specifically, the processor derives a subsequent fluid flow state from a current fluid flow state by iteratively applying the equations to each newly achieved fluid flow state, thus simulating the flow of fluid through the network of fractures. The subsequent states embody a time-dependent spatial distribution of at least one flow parameter such as velocity, pressure, proppant concentration, diverter concentration, temperature, and the like.

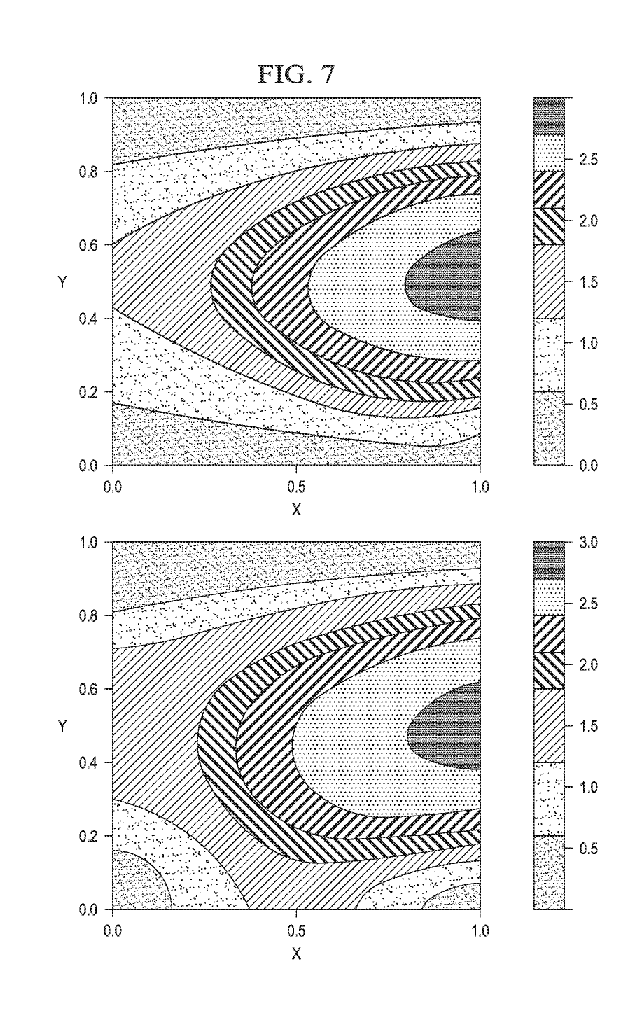

At 610, a monitor coupled to the processor displays the time-dependent spatial distribution to an operator as described with respect to FIG. 7. The time-dependent distribution may also be stored on a non-transient information storage medium.

At 612, the operator alters the fluid flow or fluid composition in the network of fractures based on the time-dependent spatial distribution. For example, the distribution is used as a prediction of the treatment operation outcome, enabling the treatment program to be evaluated and modified if necessary. In at least one embodiment, the alteration occurs automatically, i.e., without human input.

FIG. 7 shows an example of a time-dependent distribution of the velocity and pressure of fluid flow resulting from three four branches of equal area and two inlets located at the left and bottom boundaries of the junction. X and Y represent the coordinates along the two-dimensional junction. The velocity is zero at the walls and maximum at the center. The top boundary is a wall, and the inlet flow has a quadratic velocity profile with a mean of 1. The pressure is imposed in the weak formulation at the right outlet boundary as indicated by shading of the figure.

The systems and methods disclosed herein may applied to any number of branches and junctions in order to predict the flow distribution within the network, and hence the amount of fluid delivered to the fractures, accurately and quickly. In at least one embodiment, a hydraulic fracturing flow simulation method includes identifying a network of fractures including junctions where the fractures intersect. Each fracture accesses each associated junction via a respective opening. The method further includes determining a current network state that includes flow parameter values at discrete points arranged one-dimensionally along the fractures in the network and at discrete points arranged two-dimensionally across the junctions in the network. The method further includes constructing a set of equations for deriving a subsequent network state from the current network state while accounting for boundary layers at each opening. The method further includes repeatedly solving the set of equations to obtain a sequence of method network states. The sequence embodies a time-dependent spatial distribution of at least one flow parameter. The method further includes displaying the time-dependent spatial distribution.

In another embodiment, a hydraulic fracturing flow system includes a data acquisition module that identifies a network of fractures including junctions where the fractures intersect. Each fracture accesses each associated junction via a respective opening. The system further includes a processing module that determines a current network state that includes flow parameter values at discrete points arranged one-dimensionally along the fractures in the network and at discrete points arranged two-dimensionally across the junctions in the network. The processing module also constructs a set of equations for deriving a subsequent network state from the current network state while accounting for boundary layers at each opening. The processing module also repeatedly solves the set of equations to obtain a sequence of subsequent network states. The sequence embodies a time-dependent spatial distribution of at least one flow parameter. The processing module also displays the time-dependent spatial distribution.

The following features may be incorporated into the various embodiments described above, such features incorporated either individually in or conjunction with one or more of the other features. The flow parameter may be selected from the group consisting of velocity, pressure, proppant concentration, diverter concentration, and temperature. The fluid flow or fluid composition in the network of fractures may be altered based on the time-dependent spatial distribution. Determining the current network state may include using finite element modeling for the junction. Determining the current network state may include using finite difference modeling for the fractures. Repeatedly solving the set of equations may include conserving the mass flux of fluid that enters and exits the junction element through the openings. Repeatedly solving the set of equations may include conserving the momentum of fluid that enters and exits the junction through the openings. Repeatedly solving the set of equations may include determining velocities of fluid entering the junction element at the openings. Repeatedly solving the set of equations may include determining pressures of the fluid exiting the junction element at the openings. Determining the pressures of the fluid may include obtaining the pressures of the fluid from a boundary layer model. A fluid control module may initiate alteration to fluid flow or fluid composition in the network of fractures based on the time-dependent spatial distribution. Determining the current network state may cause the processing module to use finite element modeling for the junction. Determining the current network state may cause the processing module to use finite difference modeling for the fractures. Repeatedly solving the set of equations may cause the processing module to conserve the mass flux of fluid that enters and exits the junction through the openings. Repeatedly solving the set of equations may cause the processing module to conserve the momentum of fluid that enters and exits the junction through the openings. Repeatedly solving the set of equations may cause the processing module to determine velocities of fluid entering the junction at the openings. Repeatedly solving the set of equations may cause the processing module to determine pressures of the fluid exiting the junction at the openings. Determining the pressure of the fluid may cause the processing module to obtain the pressures of the fluid from a boundary layer model.

While the present disclosure has been described with respect to a limited number of embodiments, those skilled in the art will appreciate numerous modifications and variations therefrom. It is intended that the appended claims cover all such modifications and variations.

What is claimed is:

1. A hydraulic fracturing flow simulation method comprising:
identifying a network of fractures comprising junctions where said fractures intersect, each fracture accessing each associated junction via a respective opening;
determining a current network state that includes flow parameter values at discrete points arranged one-dimensionally along the fractures in said network and at discrete points arranged two-dimensionally across the junctions in the network;
constructing a set of equations for deriving a subsequent network state from the current network state while accounting for boundary layers at each opening;
repeatedly solving the set of equations to obtain a sequence of subsequent network states, the sequence embodying a time-dependent spatial distribution of at least one flow parameter; and
displaying the time-dependent spatial distribution.

2. The method of claim 1, wherein the flow parameter is selected from the group consisting of velocity, pressure, proppant concentration, diverter concentration, and temperature.

3. The method of claim 1, further comprising altering fluid flow or fluid composition in the network of fractures based on the time-dependent spatial distribution.

4. The method of claim 1, wherein determining the current network state comprises using finite element modeling for the junction.

5. The method of claim 1, wherein determining the current network state comprises using finite difference modeling for the fractures.

6. The method of claim 1, wherein repeatedly solving the set of equations comprises conserving the mass flux of fluid that enters and exits the junction element through the openings.

7. The method of claim 1, wherein repeatedly solving the set of equations comprises conserving the momentum of fluid that enters and exits the junction through the openings.

8. The method of claim 1, wherein repeatedly solving the set of equations comprises determining velocities of fluid entering the junction element at the openings.

9. The method of claim 1, wherein repeatedly solving the set of equations comprises determining pressures of the fluid exiting the junction element at the openings.

10. The method of claim 9, wherein determining the pressures of the fluid comprises obtaining the pressures of the fluid from a boundary layer model.

11. A hydraulic fracturing flow system comprising:
a data acquisition module that identifies a network of fractures comprising junctions where said fractures intersect, each fracture accessing each associated junction via a respective opening;
a processing module that:
determines a current network state that includes flow parameter values at discrete points arranged one-dimensionally along the fractures in said network and at discrete points arranged two-dimensionally across the junctions in the network;
constructs a set of equations for deriving a subsequent network state from the current network state while accounting for boundary layers at each opening;
repeatedly solves the set of equations to obtain a sequence of subsequent network states, the sequence embodying a time-dependent spatial distribution of at least one flow parameter; and
displays the time-dependent spatial distribution.

12. The system of claim 11, wherein the flow parameter is selected from the group consisting of velocity, pressure, proppant concentration, diverter concentration, and temperature.

13. The system of claim 11, further comprising a fluid control module that initiates alteration to fluid flow or fluid composition in the network of fractures based on the time-dependent spatial distribution.

14. The system of claim 11, wherein determining the current network state causes the processing module to use finite element modeling for the junction.

15. The system of claim 11, wherein determining the current network state causes the processing module to use finite difference modeling for the fractures.

16. The system of claim 11, wherein repeatedly solving the set of equations causes the processing module to conserve the mass flux of fluid that enters and exits the junction through the openings.

17. The system of claim 11, wherein repeatedly solving the set of equations causes the processing module to conserve the momentum of fluid that enters and exits the junction through the openings.

18. The system of claim 11, wherein repeatedly solving the set of equations causes the processing module to determine velocities of fluid entering the junction at the openings.

19. The system of claim 11, wherein repeatedly solving the set of equations causes the processing module to determine pressures of the fluid exiting the junction at the openings.

20. The system of claim 19, wherein determining the pressure of the fluid causes the processing module to obtain the pressures of the fluid from a boundary layer model.
